(19) United States
(12) Patent Application Publication
(10) Pub. No.: US 2025/0070486 A1
(43) Pub. Date: Feb. 27, 2025

(54) CONDUCTOR TERMINAL

(71) Applicant: WAGO Verwaltungsgesellschaft mbH, Minden (DE)

(72) Inventor: Viktor MICKMANN, Wunstorf (DE)

(73) Assignee: WAGO Verwaltungsgesellschaft mbH, Minden (DE)

(21) Appl. No.: 18/813,925

(22) Filed: Aug. 23, 2024

(30) Foreign Application Priority Data
Aug. 25, 2023 (DE) 20 2023 104 852.8

(51) Int. Cl. H01R 4/48

(52) U.S. Cl. CPC H01R 4/4811; H01R 4/4846

(57) ABSTRACT

A conductor terminal to connecting an electrical conductor, including a busbar, on which a clamping point is formed for clamping the electrical conductor. At least one three-dimensionally shaped receiving contour is arranged after the clamping point in the conductor insertion direction of the electrical conductor, which is configured to contact with and/or to receive the electrical conductor

This nonprovisional application claims priority under 35 U.S.C. § 119 (a) to German Patent Application No. 20 2023 104 852.8, which was filed in Germany on Aug. 25, 2023, and which is herein incorporated by reference.

### BACKGROUND OF THE INVENTION

### Field of the Invention

The invention relates to a conductor terminal for connecting an electrical conductor, including a busbar, on which a clamping point is formed for clamping the electrical conductor.

### Description of the Background Art

A conductor terminal is known from DE 10 2016 105 192 B3, which is incorporated herein by reference.

### SUMMARY OF THE INVENTION

It is therefore an object of the invention to further improve a conductor terminal with respect to the connection security of the electrical conductor.

In a conductor terminal of the type mentioned at the outset, this object is achieved in that the busbar has at least one three-dimensionally shaped receiving contour after the clamping point in the conductor insertion direction of the electrical conductor, which is configured for contact with and/or to receive the electrical conductor. The invention has the advantage that, due to the three-dimensionally shaped receiving contour, the position stability of the electrical conductor may be increased in the state clamped at the clamping point, and, in particular, the stable positioning at the clamping point may be improved. The receiving contour may be advantageously adapted three-dimensionally to the outer shape of the electrical conductor, so that this electrical conductor may rest here over a certain circumferential angle and thus be fixed in position at this location.

The three-dimensionally shaped receiving contour can be arranged completely after the clamping point, i.e., no part of the three-dimensionally shaped receiving contour is situated next to or in before the clamping point in the conductor insertion direction of the electrical conductor.

The receiving contour may thus at least partially receive the electrical conductor at least in a certain region. The risk of failure of the contacting point may be reduced hereby, in particular also in cases in which forces act upon the clamped electrical conductor externally from different directions. The receiving contour then leads to reduced movements of the electrical conductor at the clamping point and thus to a reduced risk of failure.

The conductor terminal may include a housing, for example an insulating housing. The busbar is then at least predominantly arranged in the housing. The housing may have an conductor insertion opening for inserting the electrical conductor to be clamped. The conductor insertion direction of the electrical conductor into the housing is simultaneously determined by the conductor insertion opening.

The busbar can have, at the clamping point, at least one clamping edge facing the electrical conductor, at which the electrical conductor may be clamped firmly in place. Due to a clamping edge of this type, the electrical conductor may be particularly reliably fixed at the clamping point, and it may not carry out any movements in the longitudinal direction, in particular in the clamped state. In addition, a clamping leg of a clamping spring may also have a clamping edge on its free end. The clamping edge may run transversely to the conductor insertion direction, in particular, orthogonally to the conductor insertion direction.

The clamping edge of the busbar can be part of a first elevation designed to be higher than the surrounding surface of the busbar. The position stability of the electrical conductor in the clamped position may be further improved hereby.

The busbar can have at least one second elevation designed to be higher than the surrounding surface of the busbar after the receiving contour in a conductor insertion direction. This second elevation, which may be, for example, rounded or formed in the shape of an edge at its apex, additionally supports the contact of the electrical conductor with the busbar. In particular, if the electrical conductor is subject to bending stress, the second elevation offers a further point of contact to avoid undefined voltage drops.

The receiving contour can be designed as a curved trough, which has a base surface which forms a support surface for the clamped electrical conductor. A trough of this type makes it possible to effectively embed the electrical conductor into the receiving contour, so that, for example, a lateral displacement of the electrical conductor is prevented or at least mitigated even in the case forces acting laterally upon the conductor. The trough may have a longitudinal axis, which runs in parallel to the conductor insertion direction of the electrical conductor. The trough may run in the longitudinal direction, i.e., in the direction of its longitudinal axis, at least essentially in parallel to the conductor insertion direction and thus in parallel to the longitudinal direction of the clamped electrical conductor. The three-dimensionally shaped receiving contour may be three-dimensionally shaped, in particular, in the respect that the base surface is designed to have multiple spherical curves in different directions of curvature.

The trough can be symmetrical to a longitudinal direction which runs in parallel to the conductor insertion direction. The electrical conductor may be particularly reliably fixed hereby in the trough against a lateral displacement.

The trough can be arranged in a third elevation designed to be higher than the surrounding surface of the busbar. Due to the third elevation, together with the trough, a kind of holder is provided for the middle region of the stripped section of the electrical conductor. At its lowest point, the trough may be situated at the same level as or slightly higher than the level of the surrounding surface of the busbar.

The base surface of the trough can be curved in a concave manner in the circumferential direction of the clamped electrical conductor. The trough may thus run in a concave manner in a section plane perpendicular to the longitudinal direction of the clamped electrical conductor. A trough of this type makes it possible to prevent or mitigate a lateral displacement of the electrical conductor even in the case of laterally acting forces.

The base surface of the trough can be curved in a convex manner or runs in a straight line in the longitudinal direction of the clamped electrical conductor. The trough is thus curved in a convex manner or formed in a straight line in a longitudinal section which runs in the longitudinal direction of the clamped electrical conductor. If the trough is formed as a straight line, the base surface may be designed, for example, as a part of a tubular lateral surface, in particular as a tubular shape having a constant radius.

The base surface of the trough can be curved in a convex manner in the longitudinal direction of the clamped electrical conductor. The base surface therefore has an apex in its profile in the longitudinal direction, i.e., a highest point, which forms an additional contact edge for the electrical conductor in the region of the trough. Viewed in the longitudinal direction, the trough thus includes a further internal elevation. Viewed from a conductor insertion opening channel of the conductor terminal, at which the electrical conductor is inserted into the housing of the conductor terminal, the apex may be arranged within the trough before the middle of the convexly curved contour of the base surface, in the middle, or after the middle. The contour curved in a convex manner in the longitudinal direction may first ascend up to the apex with a first gradient, viewed, for example, from the conductor insertion opening, and descend with a second gradient after the apex. The second gradient may be greater than the first gradient in terms of absolute value. In the case of a curved shaping in the longitudinal direction, the mean value of the ascending or descending section is viewed as the gradient.

The receiving contour can be configured by its shaping to surround the electrical conductor over a circumferential region, in particular a circumferential region having a circumferential angle of 30 degrees to 90 degrees. The electrical conductor may be particularly reliably secured hereby against a lateral displacement.

The clamping edge, the first elevation, the receiving contour, the second elevation, and/or the third elevation can be formed as a single piece from the material of the busbar, in particular by stamping, bending, and/or embossing. In this way, such additional elements of the busbar may be provided particularly easily and cost-effectively in that they are formed directly from the material of the busbar during the manufacturing of the busbar. No additional assembly steps are then necessary.

The conductor terminal can be configured to clamp the electrical conductor at the clamping point via spring-force clamping. This permits an easy and fast connection of the electrical conductor at the clamping point as well as a reliable and continuous contacting even if vibrations occur.

The conductor terminal can include a clamping spring, which has a clamping leg for clamping the electrical conductor to the clamping point. The clamping spring may additionally have a contact leg for fixing the clamping spring in the conductor terminal. The clamping spring may have a spring bend between the contact leg and the clamping leg. The clamping leg may have a clamping edge on its free end for clamping the electrical conductor firmly in place.

The clamping leg may end with a free end between the clamping point and the receiving contour. This applies at least in the state in which no electrical conductor is clamped. A design of this type makes it possible to particularly reliably clamp the electrical conductor in place and fix it in the longitudinal direction as well as in the lateral direction. The fixing in the lateral direction is supported by the receiving contour.

An electrical conductor clamped against the busbar with the aid of the clamping leg may abut one, multiple, or all elevations, i.e., the first, second, and/or third elevation(s).

Any elevation which protrudes from the otherwise usually flat surface of the contacting side in the busbar can be understood to be the elevation, regardless of the geometry and cross-sectional surface area of the elevation. The elevations may be arranged at different distances from each other in the conductor insertion direction, in particular one after the other, i.e., no other elements of the busbar present for clamping the conductor are arranged therebetween.

The busbar can have an indentation, e.g. a bead, in each case on the side facing away from the clamping point at the position of one, multiple, or all elevations. This has the advantage that the elevations may be easily manufactured on the busbar, e.g., by embossing the particular bead with the aid of an embossing tool. Due to the embossing of the bead, the particular elevation forms on the opposite side of the busbar, namely on the contacting side.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side sectional representation of a conductor terminal;

FIGS. 2 and 3 show enlarged sectional representations of region A marked in FIG. 1 in different viewing directions;

FIGS. 4 and 5 show views comparable to those in FIGS. 2, 3 without the electrical conductor;

FIG. 6 shows a perspective view of a busbar;

FIG. 7 shows a perspective view of a busbar in a longitudinal section.

### DETAILED DESCRIPTION

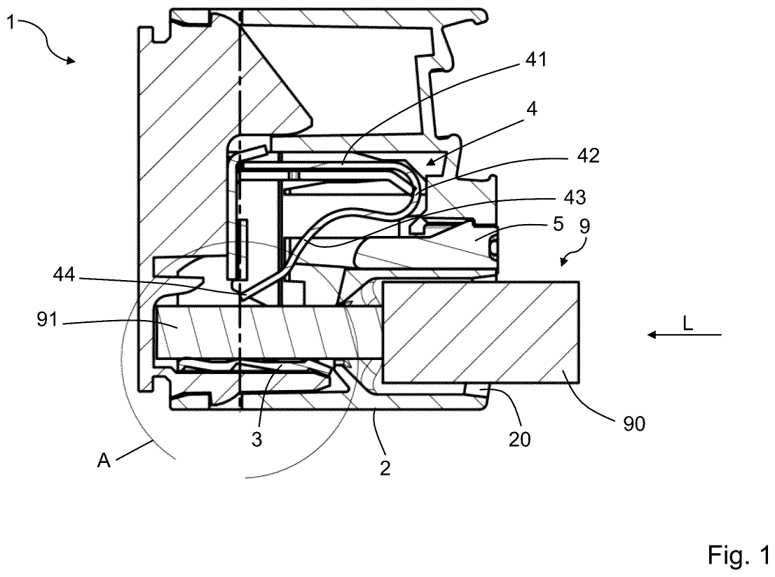

Conductor terminal 1 illustrated in FIG. 1 includes a housing 2, a busbar 3, a clamping spring 4, and an actuating element 5. Busbar 3 and clamping spring 4 are at least predominantly arranged in housing 2 and form a contact insert of conductor terminal 1, with the aid of which electrical conductor 9 may be clamped firmly in place at a clamping point formed on busbar 3 by means of spring force clamping.

Clamping spring 4 has a contact leg 41, a spring bend 42 adjacent to contact leg 41 and a clamping leg 43 adjacent to spring bend 42, which ends at a free end 44, e.g., with a clamping edge. Housing 2 has a conductor insertion opening 20. An electrical conductor 9 may be inserted into housing 2 through conductor insertion opening 20 in a conductor insertion direction L and clamped on busbar 3. As is apparent, a stripped end section 91 of electrical conductor 9, which is freed of an insulating sheathing 90, is clamped there. The clamping firmly in place takes place with the aid of clamping leg 43 of clamping spring 4. Clamping spring 4 is supported against the clamping force applied by clamping leg 43 via its contact leg 41.

The more specific details of busbar 3 are explained in greater detail below based on enlarged sectional representations of region A marked in FIG. 1.

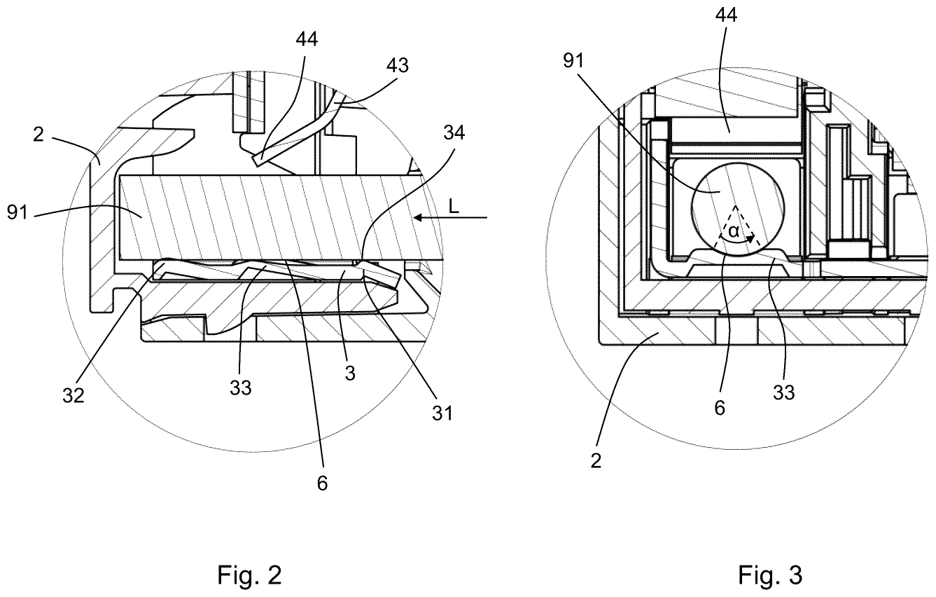

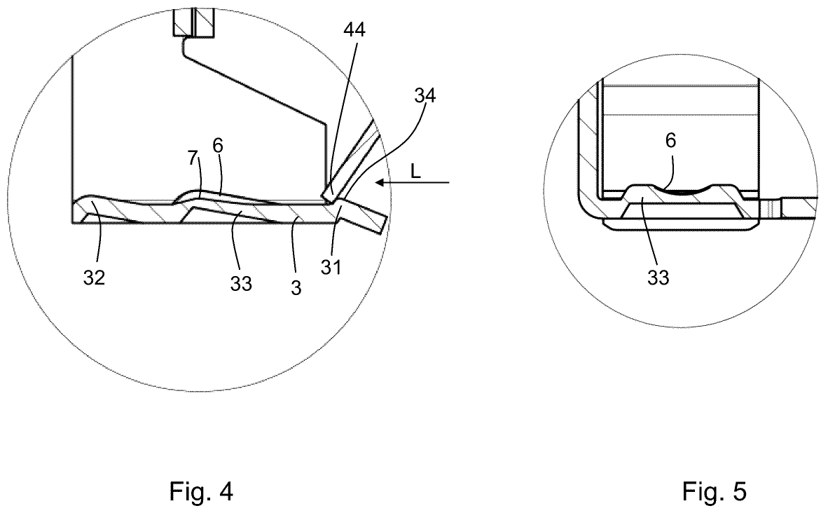

FIG. 2 shows region A in the same side sectional view as in FIG. 1. FIG. 3 shows region A in a front view of the end of stripped section 91 of electronic conductor 9. In FIG. 4, the region illustrated in FIG. 2 is reproduced without electrical conductor 9, and in FIG. 5, the region illustrated in FIG. 3 is reproduced without electrical conductor 9.

As is apparent from FIGS. 2 through 5, busbar 3 initially has a first elevation 31, viewed in conductor insertion direction L, a third elevation 33 at a certain distance thereafter, and a second elevation 32 in turn at a certain distance thereafter. First elevation 31 forms actual clamping point 34 for electrical conductor 9. First elevation 31 may have a clamping edge for this purpose at its apex, at which electrical conductor 9 may be clamped firmly in place.

A three-dimensionally shaped receiving contour 6 is present at third elevation 33, which is configured for contact with electrical conductor 9 or its stripped section 91. Receiving contour 6 may advantageously be formed as a curved trough, which extends with its longitudinal direction in parallel to conductor insertion direction L and thus to the longitudinal direction of electrical conductor 9. It is apparent in FIG. 3 that, due to its shaping, receiving contour 6 may surround electrical conductor 9 over a certain circumferential angle α, in particular, with a circumferential angle α in the range from 30 degrees to 90 degrees.

Second elevation 32 is used to additionally support electrical conductor 9.

FIG. 5, which shows receiving contour 6, including the trough, in a section plane perpendicular to conductor insertion direction L, clarifies that the trough in this section plane is designed to be curved in a concave manner in the circumferential direction of the clamped electrical conductor. Based on FIG. 4, which shows a longitudinal sectional view of receiving contour 6, including the trough, i.e., in a section plane in parallel to conductor insertion direction L, it is apparent that the base surface of the trough is designed to initially ascend in conductor insertion direction L, reaches an apex 7, and then is designed to descend again with a certain gradient. In this section plane, the base surface of the trough is thus designed to be curved in a convex manner.

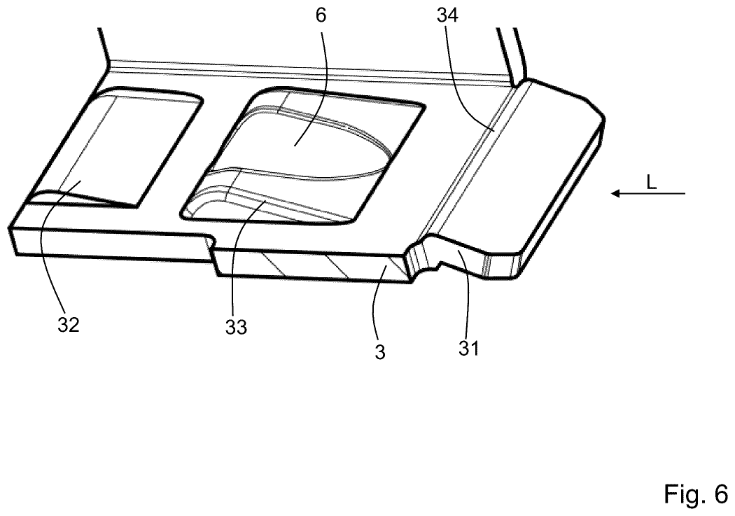

FIG. 6 shows an example of a busbar 3, including the elements already explained above, namely first elevation 31, second elevation 32, and third elevation 33, which has trough-shaped receiving contour 6. FIG. 6 clarifies, in particular, that trough-shaped receiving contour 6 does not necessarily have to be designed with the convex contour in the longitudinal direction, i.e., with apex 7, but may also be designed as a receiving contour running in a straight line in the longitudinal direction.

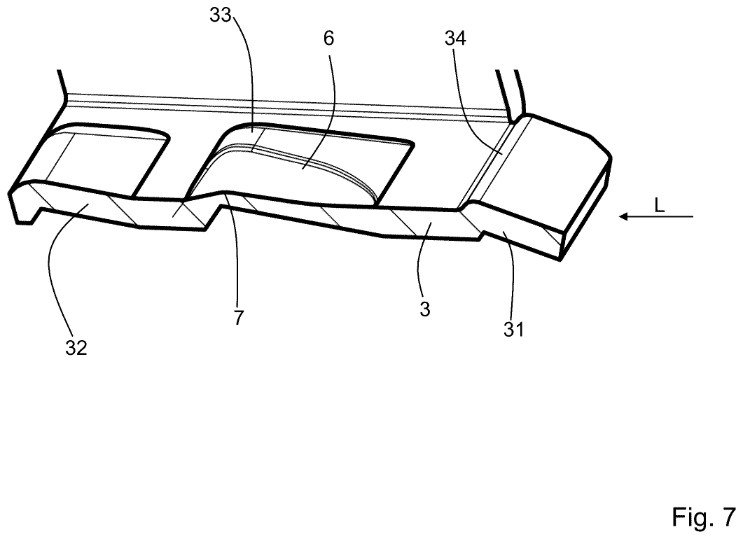

FIG. 7 shows an example of a busbar 3, including the elements explained above, in which trough-shaped receiving contour 6 has the convex shape with apex 7 in the longitudinal direction, as explained above on the basis of FIG. 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal to connect an electrical conductor, the conductor terminal comprising:
a busbar;
a clamping point formed on the busbar to clamp the electrical conductor; and
at least one three-dimensionally shaped receiving contour arranged after the clamping point in the conductor insertion direction of the electrical conductor, which is configured to contact with and/or to receive the electrical conductor.

2. The conductor terminal according to claim 1, wherein the busbar has, at the clamping point, at least one clamping edge facing the electrical conductor, at which the electrical conductor is adapted to be clamped firmly in place.

3. The conductor terminal according to claim 1, wherein the clamping edge is part of a first elevation designed to be higher than the surrounding surface of the busbar.

4. The conductor terminal according to claim 1, wherein the busbar has at least one second elevation designed to be higher than the surrounding surface of the busbar after the receiving contour in the conductor insertion direction.

5. The conductor terminal according to claim 1, wherein the receiving contour is designed as a curved trough, which has a base surface which forms a support surface for the clamped electrical conductor.

6. The conductor terminal according to claim 5, wherein the trough is symmetrical with respect to a longitudinal direction, which runs substantially in parallel to the conductor insertion direction.

7. The conductor terminal according to claim 5, wherein the trough is arranged in a third elevation designed to be higher than the surrounding surface of the busbar.

8. The conductor terminal according to claim 5, wherein the base surface of the trough is curved in a concave manner in the circumferential direction of the clamped electrical conductor.

9. The conductor terminal according to claim 5, wherein the base surface of the trough is curved in a convex manner or runs in a straight line in the longitudinal direction of the clamped electrical conductor.

10. The conductor terminal according to claim 1, wherein the receiving contour is configured by its shaping to surround the electrical conductor over a circumferential region or a circumferential region having a circumferential angle of 30 degrees to 90 degrees.

11. The conductor terminal according to claim 1, wherein the clamping edge, the first elevation, the receiving contour, the second elevation, and/or the third elevation are formed as a single piece from the material of the busbar by stamping, bending, and/or embossing.

12. The conductor terminal according to claim 1, wherein the conductor terminal is configured to clamp the electrical conductor at the clamping point by a spring force clamping.

13. The conductor terminal according to claim 12, wherein the conductor terminal includes a clamping spring, which has a clamping leg for clamping the electrical conductor at the clamping point.

14. The conductor terminal according to claim 13, wherein the clamping leg ends with a free end between the clamping point and the receiving contour.
